(19) United States
(12) Patent Application Publication
(10) Pub. No.: US 2014/0150818 A1
(43) Pub. Date: Jun. 5, 2014

(54) Automatic Photovoltaic Solar Panel Washer

(71) Applicant: Reuben H. Chow, Oakland, CA (US)

(72) Inventor: Reuben H. Chow, Oakland, CA (US)

(73) Assignee: Reuben Chow, Oakland, CA (US)

(21) Appl. No.: 13/914,591

(22) Filed: Jun. 10, 2013

Related U.S. Application Data
(60) Provisional application No. 60/690,249, filed on Jun. 14, 2005.

(51) Int. Cl. H01L 31/042

(52) U.S. Cl. CPC H02S 40/00
USPC 134/6; 15/246

(57) ABSTRACT

An Automatic (Auto) Photovoltaic (PV) Solar Panel Washer comprising a main carrier joined by a connecting member to the main mast. A main hydraulic cylinder system comprising one or more hydraulic cylinders and connector arrangement on the main mast raises the main mast up or pushes it down, activating the connecting member, thereby raising or lowering the main carrier. The positioning hydraulic cylinder determines the angle of the main carrier by pushing one end down or bringing it up. A rotating device assembly rotates the main mast and main carrier clockwise or counterclockwise from rest position over its stationary post. The main carrier comprises a rigid frame with attachments including a cleaning assembly consisting of air cylinders with cleaning wiper systems, tracks for the air cylinder shafts, wash material pipes with spray devices attached, rinse material pipes with spray devices attached, and compressed air drying pipes with air spray devices.

### CROSS-REFERENCE TO RELATED APPLICATION

The present application claims the benefit of the filing date of provisional patent application 61/690,249 filed on Jun. 21, 2012. The content of the provisional patent application is incorporated herein by reference.

### FIELD OF INVENTION

The present invention relates to an automatic photovoltaic (PV) solar panel washer. More particularly, the present invention relates to an automatic PV solar panel washer device and a method of automatic washing, cleaning and protection of PV solar panels (panels).

### BACKGROUND OF THE INVENTION

Photovoltaic (“PV”) modules, also known as solar panel modules, typically include one or more photovoltaic panels and the associated electrical wiring for connecting the module to a desired circuit. PV modules in solar “farms” are typically ground-mounted on a rack system in long rows, facing the sun at a pitched angle in order to place them in the best position for receiving the necessary sunlight to generate electricity. However, dust, dirt, debris, snow and other materials collect on the panels over time and reduce the panel efficiency and capacity to produce electrical power. Dirt and dust and other material build-up on the panels prevent sunlight from reaching the critical elements in the panel material, reducing electrical output by five to fifteen percent or more. With frequent cleaning, up to at least four times a year, depending on their location and environment the solar panels perform as optimally designed.

It would therefore be advantageous to provide a means for cleaning the solar panel in order to maximize their full potential in providing a cost effective and sustainable source of electricity. The auto PV solar panel washer of the present invention is to perform automatic washing, cleaning and protection of PV solar panels (panels). Washing, rinsing, protecting and drying functions would be performed by the auto PV solar panel washer on the panels by the equipment systems placed on a mobile wheeled device as it moves through or along a plurality of rows or arrays of panels.

The auto PV solar panel washer allows for a more efficient, cost effective and safe washing of panels, than when compared to manual washing. The auto PV solar panel washer in performing the washing, cleaning and protection of the solar panels would enable the panels to restore losses in capacity and hence to restore their maximum electrical power generating capability.

U.S. Pat. No. 8,430,724 discloses surface cleaning system and method of efficiently removing stain, including high adhesive substance, from a surface, especially a surface of an automobile. The cleaning operation can be completed by either hand operation or machine operation. The user is able to select the compressible body being coupled with a hand held actuator for hand operation or a machine buffering device for machine operation.

JP S6076175 discloses automatically washing the panels with wipers usually held to stand vertically to the ground while in washing. The wipers are laid to be contacted closely with the panel face, so that the panel face is washed by the wipers driven by drive means with water flowing over the panel face.

JP2012124303 discloses solar panel cleaning device comprising a groove installed at both side parts of a solar panel maintenance frame. One end and the other end of the groove are respectively closed. A roll brush or channel brush washes the surface of a solar panel. Both end parts of a roll brush or a channel brush are supported by the groove.

### SUMMARY OF THE INVENTION

It is an object of the present invention to provide an automated means of washing, cleaning and protecting PV solar panels which allows fast, safe and effective cleaning, and result in restoration and maintenance of their maximum electrical power production capacity. Ground-mounted Solar panel installations may range from a few rows of panels (1000+ panels) to over 500,000+ panels. An automated means would provide consistent, safe and efficient washing, cleaning and protection of panels.

One aspect of the present invention relates to an automatic (auto) photovoltaic (PV) solar panel washer comprising:
a main carrier joined by a connecting member to a main mast;
a main hydraulic cylinder system comprising one or more hydraulic cylinders and connector arrangement on the main mast controls the raising and lowering of the main carrier and a positioning hydraulic cylinder controls the angle of the main carrier;
a rotating device assembly rotates the main mast and main carrier about the stationary post, from rest position to working position, clockwise or counterclockwise.
said main carrier comprising a rigid frame with attachments including a cleaning assembly comprising air cylinders with attached cleaning wipers, tracks for the air cylinder shafts, wash material pipes with spray devices, rinse material pipes with spray devices and compressed air drying pipes with air spray devices.

One aspect of the present invention relates to the main carrier comprising two (2) air cylinders oriented to move cleaning wiper assemblies attached to the ends of the shafts back and forth along the faces or active surfaces of the PV solar panels thereby cleaning the panels of dirt, dust, debris, snow or other material.

One aspect of the present invention relates to the auto PV solar panel washer wherein the wash and rinse material pipes, spray devices and the compressed air pipes and air spray devices provide washing, rinsing and blow drying of the solar panel surfaces during and after the cleaning cycles.

Another aspect of the present invention relates to the auto PV solar panel washer wherein for some materials including snow, only the compressed air pipes would be activated for blow drying after cleaning.

Another aspect of the present invention relates to the auto PV solar panel washer comprising a rotating device assembly which rotates the main mast and hence the main carrier from rest position to working position, clockwise or counterclockwise to attain its working position above the tops of a row of PV solar panels.

Another aspect of the present invention relates to the auto PV solar panel washer wherein the main carrier is moved up or down by the main mast which is joined to the main carrier by a connecting member. The main mast is pushed down or raised up by one or more hydraulic cylinders and connector arrangement for the main carrier to attain the appropriate distance above the tops of a row of PV solar panels.

Another aspect of the present invention relates to the auto PV solar panel washer wherein the positioning hydraulic cylinder pushes one end of the main carrier down or raises it up to attain the desired angle of approximately 15-45 degrees above the tops of a row of PV solar panels.

Another aspect of the present invention relates to the auto PV solar panel washer wherein a control panel performs automatic controls of the connected mechanisms and systems. The control panel is located on the floor of the mobile wheeled device.

Another aspect of the present invention relates to the auto PV solar panel washer wherein various equipment and prime mover devices are placed on the floor of the mobile wheeled device including the main mast, rotating device assembly and stationary post, two (2) water tanks, an electric generator, an air compressor, a hydraulic tank and pump system, and a chemical mixing tank.

Another aspect of the present invention relates to the auto PV solar panel washer wherein the main carrier is placed in its rest position on brackets in a pan along the bed of the mobile wheeled device for safety and security when travelling over roads and when the auto PV solar panel washer is not in use.

Another aspect of the present invention relates to the auto PV solar panel washer wherein the cleaning wiper system is a mechanical device or assembly whereby the wiper device is comprised of various materials including fabric, rubber, plastic, natural, manmade or a hybrid material, with soft surfaces or otherwise, and whether the material condition is stiff or otherwise. The materials are attached by various means, or the materials are an integral part of the cleaning wiper system.

Another aspect of the present invention relates to the auto PV solar panel washer wherein the cleaning cycle is supplied with clean water including de-ionized (DI) water and additives including bio-degradable materials for detergent and dust repellent action, through wash material pipes with spray devices attached and rinse material pipes with spray devices attached. The cleaning cycle is also supplied with compressed air for drying via piping with air spray devices attached.

Another aspect of the present invention relates to the auto PV solar panel washer system wherein the systems are installed on a mobile wheeled device which is self powered or directly connected to a powered vehicle or powered wheeled device. The operator of the powered wheeled device has a remote control device linked to the control panel for remote control of the equipment and prime mover systems on the mobile wheeled device. The operator also has a vertical position laser guide and annunciator to indicate the position of the main carrier and a visual display to observe the operations as seen from the movie camera mounted at the rear of the mobile wheeled device.

Another aspect of the present invention relates to or comprises of the main carrier which is a rigid frame with fixed mechanisms designed to wash, clean and dry the PV panels automatically.

Another aspect of the present invention relates to a method of protecting PV solar panels comprising a sequence of operations and mechanical actions by the mechanisms on the main carrier while it is a certain distance above and perpendicular to the rows of panels, while approximately parallel to the individual panels in their rows.

Another aspect of the present invention relates to a method of protecting PV solar panels comprising:
spray washing an entire panel surface from wash material pipes with attached spray devices; stopping the spray after a short interval;
activating the cleaning wiper system with each air cylinder working in opposite directions (out-in, out-in) cleaning the panel surfaces;
optionally, spray washing the surface with water and a bio-degradable and dust repellent material while the cleaning wiper system is in action;
stopping the wiper system after a few strokes by each cylinder with each cylinder fully retracted;
spray rinsing the entire panel surface from spray material pipes with attached spray devices; stopping the spray after a short interval;
air drying the panel surface by releasing compressed air from air pipes with air spray attached devices; stopping after a short interval; and
applying a bio-degradable dust repellent material as required.

Another aspect of the present invention relates to the cleaning wiper system comprising a mechanical device which holds the cleaning media in place with the wiper system attached at the end of an air cylinder. The cleaning wiper system is used after the PV panels have been spray washed or during the washing cycle to agitate and remove dust, dirt, debris, and other materials from the panel surfaces. In dry applications, for instance removing snow, no water is used.

Another aspect of the present invention relates to the use of air cylinders to cause the cleaning wiper system to clean the surfaces of the panels with the air cylinder shafts moving in and out thereby moving the cleaning wiper system back and forth along the surfaces of the PV panels.

Another aspect of the present invention relates to the use of the hydraulic cylinders, with one or more hydraulic cylinder and connector arrangement raising and lowering the main mast and hence adjusting the position of the main carrier to achieve a safe distance above the panel surfaces. The positioning hydraulic cylinder determines the angle of the main carrier by pushing one end up or down until the main carrier reaches the desired angle above the panel surfaces for the washing, cleaning, rinsing and drying operations.

Another aspect of the present invention relates to the rotating device assembly comprising a powered motor driving a rotating system which causes the main mast, the connecting member and the main carrier to rotate clockwise or counter-clockwise from the rest position. The rotating device is attached to the main mast set over the stationary post. The rotation allows the main carrier to move from its rest position in the pan to its working position perpendicular to the bed of the mobile wheeled device.

These and other aspects of the invention will become apparent upon reading the present specification, accompanying drawings and claims.

### BRIEF DESCRIPTION OF THE DRAWINGS

Reference is made in detail to a preferred embodiment of the invention, an example of which is illustrated in the accompanying sheets FIG. 1 through FIG. 4.

FIG. 1 is a schematic plan view of the auto PV solar panel washer equipment systems on the mobile wheeled device.

FIG. 2 is a schematic angular view from the side of the auto PV solar panel washer showing the main mast and connecting member and the main carrier. The hydraulic cylinders and rotating device assembly are also shown.

FIG. 3 is a schematic angular view of the main mast and main carrier, the connecting member and the positioning hydraulic cylinder. A typical PV solar panel installed in the field is shown with the main carrier some distance above it in a typical operational mode.

FIG. 4 is a schematic showing details of the main carrier, the air cylinder and cleaning wiper device.

### DETAILED DESCRIPTION OF INVENTION

In the following description, as used herein, the words “automatic PV solar panels,” “auto PV solar panels,” “PV panels” or “panels” all refer to one and the same thing and may be used interchangeably. Similarly, the words such as “Deionized water” “DI water” “wash water” “rinse water” or “water” have the same meaning and may be used interchangeably.

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

One embodiment of the invention relates to an automatic (auto) photovoltaic (PV) solar panel washer comprising:
a main carrier joined by a connecting member to a main mast;
a main hydraulic system comprising one or more hydraulic cylinders and connector arrangement on the main mast controls the raising and lowering of the main carrier and a positioning hydraulic cylinder controls the angle of the main carrier;
a rotating device assembly rotates the main mast and main carrier about the stationary post, from rest position to working position, clockwise or counterclockwise;
said main carrier comprising a rigid frame with attachments including a cleaning assembly comprising air cylinders with attached cleaning wipers, tracks for the air cylinder shafts, wash material pipes with spray devices, rinse material pipes with spray devices and compressed air drying pipes with air spray devices.

Another embodiment of the invention relates to the main carrier comprising two (2) air cylinders oriented to move cleaning wiper assemblies attached to the ends of the shafts back and forth along the faces or active surfaces of the PV solar panels thereby cleaning the panels of dirt, dust, debris, snow or other material.

Another embodiment of the invention relates to the auto PV solar panel washer wherein the wash and rinse material pipes, spray devices and the compressed air pipes and air spray devices provide washing, rinsing and blow drying of the solar panel surfaces during and after the cleaning cycles.

Another embodiment of the invention relates to the auto PV solar panel washer wherein for some materials including snow, only the compressed air pipes would be activated for blow drying after cleaning.

Another embodiment of the invention relates to the auto PV solar panel washer comprising a rotating device assembly rotates the main mast and hence the main carrier from rest position to working position, clockwise or counterclockwise to attain its working position above the tops of a row of PV solar panels.

Another embodiment of the invention relates to the auto PV solar panel washer wherein the main carrier is moved up or down by the main mast which is joined to the main carrier by a connecting member. The main mast is pushed down or raised up by one or more hydraulic cylinders and connector arrangement for the main carrier to attain the appropriate distance above the tops of a row of PV solar panels.

Another embodiment of the invention relates to the auto PV solar panel washer wherein the positioning hydraulic cylinder pushes one end of the main carrier down or raises it up to attain the desired angle above the tops of a row of PV solar panels.

Another embodiment of the invention relates to the auto PV solar panel washer wherein a control panel performs automatic controls of the connected mechanisms and systems. The control panel is located on the floor of the mobile wheeled device.

Another embodiment of the invention relates to the auto PV solar panel washer wherein various equipment and prime mover devices are placed on the floor of the mobile wheeled device including the main mast, rotating device assembly and stationary post, two (2) water tanks, an electric generator, an air compressor, a hydraulic tank and pump system, and a chemical mixing tank.

Another embodiment of the invention relates to the auto PV solar panel washer wherein the main carrier is placed in its rest position on brackets in a pan along the bed of the mobile wheeled device for safety and security when travelling over roads and when the auto PV solar panel washer is not in use.

Another embodiment of the invention relates to the auto PV solar panel washer wherein the cleaning wiper system is a mechanical device or assembly whereby the wiper device is comprised of various materials including fabric, rubber, plastic, natural, manmade or a hybrid material, with soft surfaces or otherwise, and whether the material condition is stiff or otherwise. The materials are attached by various means, or the materials are an integral part of the cleaning wiper system.

Another embodiment of the invention relates to the auto PV solar panel washer wherein the cleaning wiper system materials are attached by various means selected from bolting, clamping, cementing, plastic molding or combinations thereof as one piece or various other means.

Another embodiment of the invention relates to the auto PV solar panel washer wherein the cleaning cycle is supplied with clean water including de-ionized (DI) water and additives including bio-degradable materials for detergent and dust repellent action, through wash material pipes with spray devices attached and rinse material pipes with spray devices attached. The cleaning cycle is also supplied with compressed air for drying via piping with air spray devices attached.

Another embodiment of the invention relates to the auto PV solar panel washer system wherein the systems are installed on a mobile wheeled device which is self powered or directly connected to a powered vehicle or powered wheeled device. The operator of the powered wheeled device has a remote control device linked to the control panel for remote control of the equipment and prime mover systems on the mobile wheeled device. The operator also has a vertical position laser guide and annunciator to indicate the position of the main carrier and a visual display to observe the operations as seen from the movie camera mounted at the rear of the mobile wheeled device.

Another embodiment of the invention relates to or comprises of the main carrier which is a rigid frame with fixed mechanisms designed to wash, clean and dry the PV panels automatically.

Another embodiment of the invention relates to a method of protecting PV solar panels comprising a sequence of operations and mechanical actions by the mechanisms on the main carrier while it is a certain distance above and perpendicular to the rows of panels, while approximately parallel to the individual panels in their rows.

Another embodiment of the invention relates to a method of protecting PV solar panels comprising:
spray washing an entire panel surface from wash material pipes with attached spray devices; stopping the spray after a short interval;
activating the cleaning wiper system with each air cylinder working in opposite directions (out-in, out-in) cleaning the panel surfaces;
optionally, spray washing the surface with water and a bio-degradable and dust repellent material while the cleaning wiper system is in action;
stopping the wiper system after a few strokes by each cylinder with each cylinder fully retracted;
spray rinsing the entire panel surface from spray material pipes with attached spray devices; stopping the spray after a short interval;
air drying the panel surface by releasing compressed air from air pipes with air spray attached devices; stopping after a short interval; and
applying a bio-degradable dust repellent material as required.

Another embodiment of the invention relates to the method of protecting PV solar panels wherein the spray rinsing or air drying is stopped after a short interval of approximately 4-6 seconds.

Another embodiment of the invention relates to the cleaning wiper system comprising a mechanical device which holds the cleaning media in place with the wiper system attached at the end of an air cylinder. The cleaning wiper system is used after the PV panels have been spray washed or during the washing cycle to agitate and remove dust, dirt, debris, and other materials from the panel surfaces. In dry applications, for instance removing snow, no water is used.

Another embodiment of the invention relates to the use of air cylinders to cause the cleaning wiper system to clean the surfaces of the panels with the air cylinder shafts moving in and out thereby moving the cleaning wiper system back and forth along the surfaces of the PV panels.

Another embodiment of the invention relates to the use of the hydraulic cylinders, with one or more hydraulic cylinders and connector arrangement raising and lowering the main mast and hence adjusting the position of the main carrier to achieve a safe distance above the panel surfaces. The positioning hydraulic cylinder determines the angle of the main carrier by pushing one end up or down until the main carrier reaches the desired angle above the panel surfaces for the washing, cleaning, rinsing and drying operations.

Another embodiment of the invention relates to the rotating device assembly comprising a powered motor driving a rotating system which causes the main mast, the connecting member and the main carrier to rotate clockwise or counter-clockwise from the rest position. The rotating device is attached to the main mast set over the stationary post. The rotation allows the main carrier to move from its rest position in the pan to its working position perpendicular to the bed of the mobile wheeled device.

Certain exemplary but non-limiting embodiments of the present invention are now described for illustrative purposes only, with reference to the attached drawings.

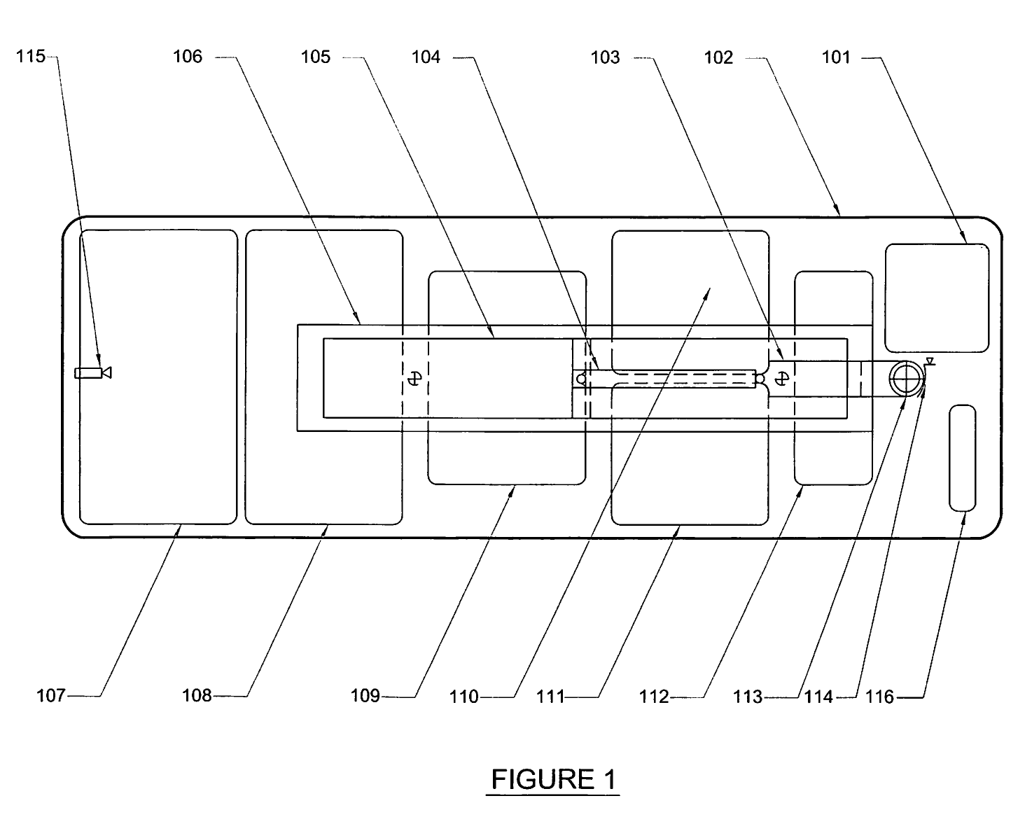

With reference to FIG. 1, there is illustrated one aspect of the present invention. With reference to FIG. 1, it depicts the arrangement of the equipment systems on the mobile wheeled device (102). The device comprises an equipment pump pad area (101) which includes the floor of the mobile wheeled device (102); the main carrier (105) is joined by connecting member (104) to the main mast (103); the pan (106); two (2) main clean water tanks (107 and 108); an electrical generator (109); an air compressor and tank (110); a hydraulic oil tank and pump system (111); a chemical mixing tank (112); the rotating device assembly (113); a vertical position laser guide and annunciator (114); the electrical control panel (116); and a movie camera (115).

Various equipment and prime mover devices are placed on the floor of the mobile wheeled device including two (2) water tanks (107, 108), an electric generator (109), an air compressor and tank system (110), a hydraulic tank and pump system (111) and a chemical mixing tank and pump system (112). An equipment pump pad area (101) is located at one end. A movie camera (115) is fixed at the top area of water tank (107). A vertical position laser guide and annunciator (114) is located on the main mast. A control panel (116) performs automatic controls of the mechanisms described herein.

The mobile wheeled device (102) is itself powered or attached to a powered vehicle or device to provide mobility in performing its functions. The operator of the powered vehicle or device would have a remote control device linked to the control panel (116) for remote control of the functions described herein, and also a vertical position laser guide and annunciator (114) to gauge the position of the main carrier (105), and a visual display to observe the operations seen from the movie camera (115).

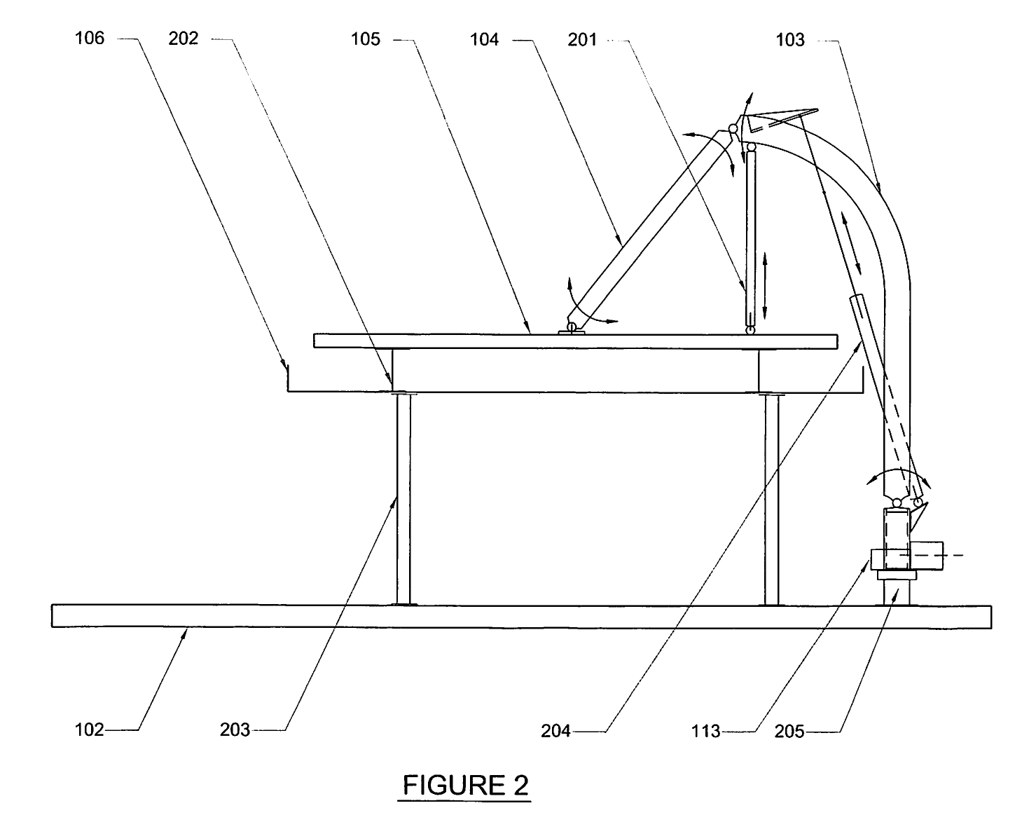

Referring to FIG. 2 which depicts an angular view of the system, comprising: the main mast (103); the connecting member (104); the positioning hydraulic cylinder (201) determines the angle of the main carrier (105); a support bracket (202) on which the main carrier is placed is in its rest position in the pan; the pan (106) where the main carrier is placed in its rest position on the support brackets; the floor of the mobile wheeled device (102); a support stand (203) which supports the pan; the main hydraulic cylinder (204) on the main mast (103) raises the main mast up or pushes it down by at least approximately 12-24 inches, activating the connecting member thereby raising or lowering the main carrier (105); the rotating device assembly (113) rotates the main mast (103) and the main carrier (105) clockwise or counterclockwise from the “rest position” over its stationary post (205).

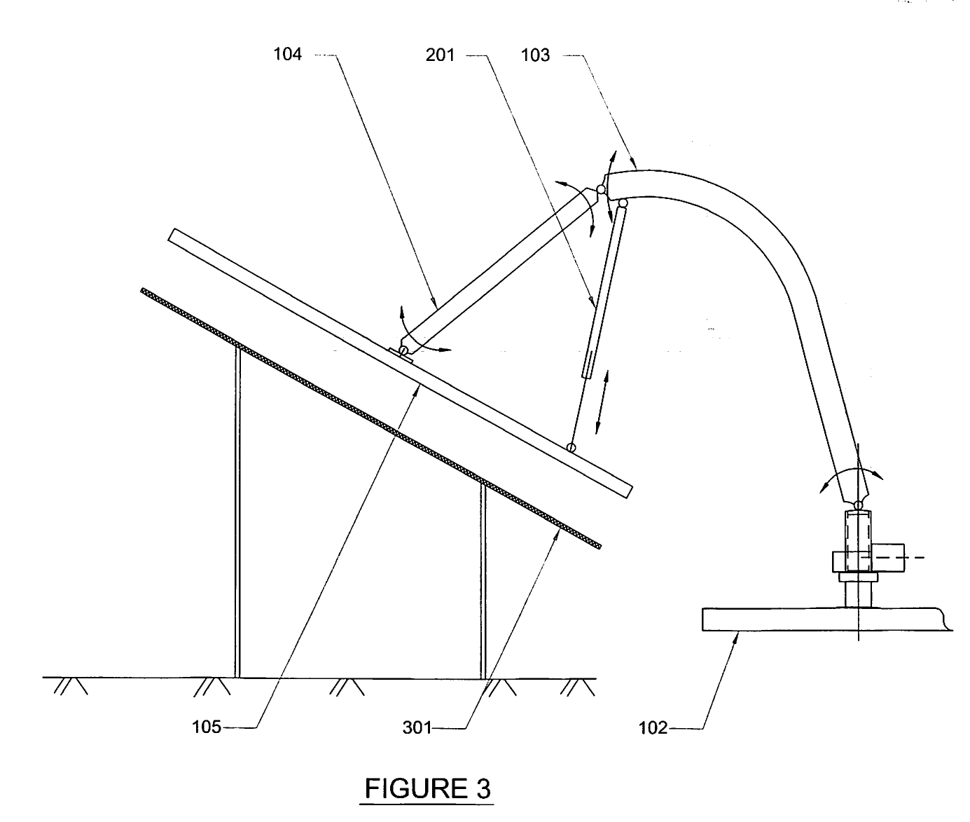

Referring to FIG. 3, which depicts an angular view of the assembly, comprising: the main mast (103) joined to the main carrier (105) by connecting member (104) and; the positioning hydraulic cylinder (201) determines the angle of the main carrier (105); a PV solar panel is typically installed in the field (301); the floor of the mobile wheeled device (102).

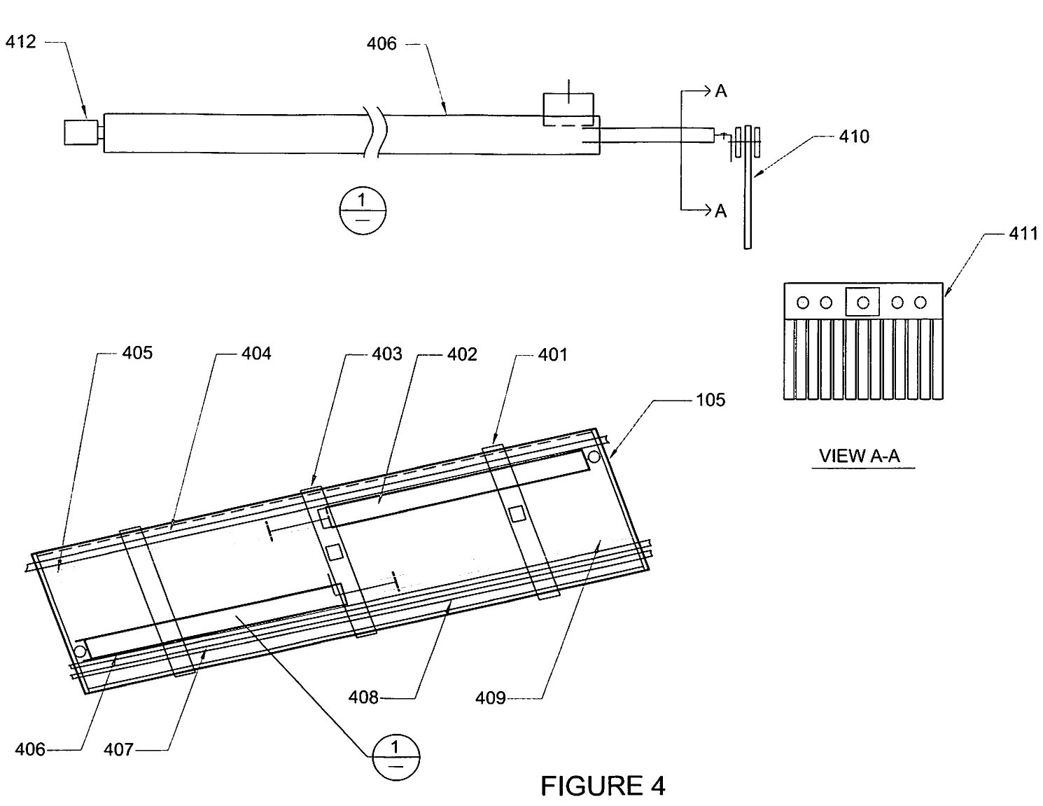

FIG. 4 depicts the main carrier and supporting equipment comprising: a rigid frame of the main carrier (105) with attachments including a cleaning assembly comprising air cylinders (402 and 406) with attached cleaning wiper systems (410, 411), cylinder tracks (405, 409) for the air cylinder shafts, wash material pipes with attached spray devices (408), rinse material pipes with attached spray device for rinse material (407) and compressed drying pipes with attached spray devices. The cross member (401) which supports the pipes and air cylinder tracks and provides an attachment at its center for the positioning hydraulic cylinder (204); the cross member (403) which supports the air cylinder and pipes and provides an attachment at its center for the connecting member; the compressed air pipe (404).

The cylinder tracks (405, 409) provide support for the air cylinder shafts as they move in and out; the connection (412) is at the base of the cylinder to the rigid frame.

The main mast (103) and rotating device assembly (113) are placed over the stationary post (205) located on the floor of a mobile wheeled device (102). The main carrier is placed in its “rest position” on brackets (202) located in a “pan” (106). The pan is supported on stands (203) located on the floor of the mobile wheeled device.

The inventions described above are, of course, susceptible to many variations, combinations of disclosed components, modifications and changes, all of which are within the skill of the art. It should be understood that all such variations, modifications and changes are within the spirit and scope of these herein described inventions. Similarly, it will be understood that inventor intends to cover and claim all changes, modifications and variations of the examples of the preferred embodiments of the invention herein disclosed for the purpose of illustration which do not constitute departures from the spirit and scope of the present invention as claimed.

Although several preferred embodiments are illustrated and described above, there are possible combinations using other geometries, sensors, materials and different dimensions for the components that perform the same functions. This invention is not limited to the above embodiments and should be determined by the following claims.

1. An automatic (auto) photovoltaic (PV) solar panel washer comprising:
a main carrier joined by a connecting member to a main mast;
a main hydraulic cylinder system comprising one or more hydraulic cylinders and connector arrangement on the main mast which controls the raising and lowering of the main carrier;
a positioning hydraulic cylinder which controls the angle of the main carrier;
a rotating device assembly rotates the main mast and main carrier about the stationary post, from rest position to working position, clockwise or counterclockwise;
said main carrier comprising a rigid frame with attachments including a cleaning assembly comprising air cylinders with attached cleaning wipers, tracks for the air cylinder shafts, wash material pipes with spray devices, rinse material pipes with spray devices and compressed air drying pipes with air spray devices.

2. The auto PV solar panel washer according to claim 1, wherein the main carrier has two (2) air cylinders oriented to move cleaning wiper assemblies attached to the ends of the shafts back and forth along the faces or active surfaces of the PV solar panels thereby cleaning the panels of dirt, dust, debris, snow or other material.

3. The auto PV solar panel washer according to claim 1, wherein a plurality of devices selected from wash material pipes, rinse material pipes, spray devices, the compressed air pipes or air spray devices provide washing, rinsing and blow drying of the solar panel surfaces during and after the cleaning cycles.

4. The auto PV solar panel washer according to claim 3, further comprising air pipes are activated for blow drying after cleaning when devices are selected for removal of snow or ice.

5. The auto PV solar panel washer according to claim 1, further comprising a rotating device assembly which rotates the main mast and configures the main carrier from rest position to working position, clockwise or counterclockwise to attain its working position above the tops of a plurality of row or arrays of PV solar panels.

6. The auto PV solar panel washer according to claim 5, wherein the rotating device assembly rotates the main mast and main carrier clockwise or counterclockwise from rest position over its stationary post.

7. The auto PV solar panel washer according to claim 1, wherein the main mast is pushed down or raised up approximately 12-24 inches by one or more hydraulic cylinders and connector arrangement for the main carrier to attain an appropriate distance above the tops of a plurality of rows or arrays of PV solar panels.

8. The auto PV solar panel washer according to claim 1, wherein the positioning of the hydraulic cylinder pushes one end of the main carrier down or raises it up to attain the desired angle of approximately 15-45 degrees above the tops of a plurality of rows or arrays of PV solar panels.

9. The auto PV solar panel washer according to claim 1 further comprising a control panel is positioned on the floor of a mobile wheeled device; said control panel performing automatic controls of the connected mechanisms and systems.

10. The auto PV solar panel washer according to claim 1, further comprising various equipments and prime mover devices which are positioned on the floor of a mobile wheeled device; said devices selected from a group consisting of the main mast, rotating device assembly and stationary post, two (2) water tanks, an electric generator, an air compressor, a hydraulic tank and pump system, a chemical mixing tank or combinations thereof.

11. The auto PV solar panel washer according to claim 1, wherein the main carrier is placed in its rest position on brackets in a pan along the bed of the mobile wheeled device for safety and security when travelling over roads or when the auto PV solar panel washer is not in use.

12. The auto PV solar panel washer according to claim 1, wherein the cleaning wiper system further comprises a mechanical device or assembly; wherein the wiper device is comprised of various materials selected from a group consisting of fabric, rubber, plastic, natural, manmade or a hybrid material, with soft surfaces or other materials whether the material condition is stiff or otherwise.

13. The auto PV solar panel washer according to claim 12 wherein the wiper system is attached at the end of an air cylinder.

14. The auto PV solar panel washer according to claim 10 wherein the materials are attached by various means or the materials are an integral part of the cleaning wiper system; said various means selected from bolting, clamping, cementing, plastic molding or combinations thereof as one piece or various other means.

15. The auto PV solar panel washer according to claim 10 wherein for a cleaning cycle, the device comprises clean water including de-ionized (DI) water and additives including bio-degradable materials for detergent and dust repellent action, through wash material pipes with spray devices attached and rinse material pipes with spray devices attached.

16. The auto PV solar panel washer according to claim 15 wherein cleaning cycle is supplied with compressed air for drying through piping with attached air spray devices.

17. The auto PV solar panel washer according to claim 1, further comprising a mobile wheeled device where the systems are installed; said device is self powered or directly connected to a powered vehicle or powered wheeled device.

18. The auto PV solar panel washer according to claim 16, wherein an operator of the powered wheeled device has a remote control device linked to the control panel for remote control of the equipment and prime mover systems on the mobile wheeled device.

19. The auto PV solar panel washer according to claim 16, wherein an operator has a vertical position laser guide and annunciator to indicate the position of the main carrier and a visual display to observe operations as seen from the movie camera mounted at the rear of the mobile wheeled device.

20. A method of protecting auto PV solar panel comprising:
spray washing an entire solar panel surface from wash material pipes with attached spray devices; stopping the spray washing after a short interval;
activating the cleaning wiper system with each air cylinder working in opposite directions (out-in, out-in) cleaning the panel surfaces;
optionally, spray washing the surface with water and a bio-degradable and dust repellent material while the cleaning wiper system is in action;
stopping the wiper system after a few strokes by each cylinder with each cylinder fully retracted;
spray rinsing the entire panel surface from spray material pipes with attached spray devices; stopping the spray rinsing after a short interval of approximately 4-6 seconds;
air drying the panel surface by releasing compressed air from air pipes with air spray attached devices; stopping after a short interval of approximately 4-6 seconds; and
applying a bio-degradable dust repellent material as required.
